(19) United States
(12) Patent Application Publication
(10) Pub. No.: US 2025/0216642 A1
(43) Pub. Date: Jul. 3, 2025

(54) ROLLED OPTICAL FIBER RIBBON

(71) Applicant: CommScope Technologies LLC, Hickory, NC (US)

(72) Inventors: Nathan HATCH, Hickory, NC (US); Zachary S. CLAMPITT, Conover, NC (US)

(73) Assignee: CommScope Technologies LLC, Hickory, NC (US)

(21) Appl. No.: 18/853,355

(22) PCT Filed: Apr. 3, 2023
(86) PCT No.: PCT/US2023/017310

§ 371 Date: Oct. 1, 2024

Related U.S. Application Data
(60) Provisional application No. 63/326,500, filed on Apr. 1, 2022.

(51) Int. Cl. G02B 6/44

(52) U.S. Cl. CPC G02B 6/448; G02B 6/4482

(57) ABSTRACT

An optical fiber ribbon is manufactured in a rolled configuration so that the rolled configuration is the natural state for the optical fiber ribbon. The optical fiber ribbon is curled into the rolled configuration as the fibers are sequentially added to the ribbon. For example, the ribbon can be indexed in a spiral as each new fiber is bonded to the previously added fiber.

### CROSS-REFERENCE TO RELATED APPLICATION

This application is being filed on Apr. 3, 2023, as a PCT International application and claims the benefit of and priority to U.S. Provisional Application No. 63/326,500, filed April 1, 2022. the disclosure of which is hereby incorporated by reference in its entirety.

### BACKGROUND

A traditional optical fiber ribbon includes a plurality of optical fibers secured together by a relatively rigid matrix material. The matrix material prevents relative movement between the optical fibers of the fiber ribbon and retains the optical fibers in a row. In particular, the matrix material retains the optical fiber in a linear array such that at any given location along the length of the fiber ribbon the optical fibers are retained in a planar arrangement by the matrix material. The matrix material protects the optical fibers, allows the optical fibers to be handled as a group, and maintains the optical fibers in a predetermined sequence. However, the matrix material also provides the fiber ribbon with a preferred bend orientation and the planar configuration has driven cable designs and fiber management systems having fiber densities that are lower than what is sometimes desired in the marketplace. The optical fibers of a traditional fiber ribbon can be separated from each other (e.g., by stripping off the matrix material) to prepare the optical fibers for splicing or termination.

In recent years, so called “rollable” optical fiber ribbon has increased in commercial acceptance and popularity. In a rollable optical fiber ribbon, the optical fibers are interconnected by bonding material such that the optical fibers are maintained in a predetermined sequence and can be handled together as a group. However, in contrast to a traditional optical fiber ribbon, the optical fibers of a rollable fiber ribbon can be moved relative to one another to a rolled, bunched, or other type of non-planar configuration. The mechanical attributes of rollable optical fiber ribbon have opened the possibility for cable configurations and fiber management systems having higher fiber densities than was possible with traditional optical fiber ribbon. Rollable optical fiber ribbons have been developed with different designs. For example, rollable optical fiber ribbon designs can include intermittent connection points between the optical fibers (e.g., staggered or non-staggered connection points), a sheet of flexible matrix material connecting the optical fibers, a continuous layer of slitted matrix material connecting the optical fibers, beads of matrix material connecting the optical fibers, or other ribbon designs. Example documents disclosing example rollable optical fiber ribbons include: U.S. Pat. Nos. 5,682,454; 10,185,105; 9,880,368; 10,488,609; 10,488,609; 10,007,078; 9,995,896; 9,086,555; and U.S. Patent Application Publication No. 2020/0271879.

### SUMMARY

Some aspects of the disclosure are directed a method of manufacturing an optical fiber ribbon in a rolled configuration. The method includes rolling the optical fiber ribbon as a plurality of fibers are sequentially added to the optical fiber ribbon. In certain examples, sequentially adding the fibers includes progressively applying bonding material as the optical fibers are curled into the rolled configuration. In certain implementations, a fiber ribbon is curled into a spiral configuration and each new optical fiber is added to an outer leg of the spiral. In certain implementations, the optical fiber ribbon is routed through a sequence of indexing fixtures. A new fiber is added to the ribbon at each indexing fixture. Each indexing fixture repositions the ribbon so that a new optical fiber is aligned with a lateral end of the ribbon. Bonding material such as a curable adhesive material is dispensed onto contiguous surfaces of the new fiber and the lateral end of the ribbon (e.g., continuously or intermittently) to bond the new fiber to the ribbon.

In some examples, the bonding material dispensed at each indexing fixture is cured at the same indexing fixture. In other examples, the bonding material is partially cured at each indexing fixture and fully cured at a final fixture. In an example, the final fixture is the last indexing fixture. In another example, the final fixture is a curing device (e.g., a source of radiant energy such as UV light emitter, an oven, etc.). In still other examples, the bonding material remains uncured until the final fixture.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a transverse cross-sectional profile of an example fiber ribbon manufactured in a rolled configuration, the cross-sectional profile taken along cross-section line 1-1 of FIG. 5;

FIG. 2 illustrates a process by which optical fibers can be added to the fiber ribbon using indexing fixtures;

FIG. 2A is an enlarged view of a portion of FIG. 2;

FIG. 3 is a schematic diagram of an example manufacturing system configured to implement the process of FIG. 2, the manufacturing system including payout reels, indexing fixtures, an accumulator, and a take-up spool;

FIG. 4 is a schematic diagram of an example indexing fixture suitable for use with the manufacturing system of FIG. 3;

FIG. 5 is a top plan view of an example fiber ribbon manufactured in a rolled configuration, an inner portion of the rolled ribbon being extended from an outer portion for ease in viewing;

FIG. 6 shows a color-coded indicator loosely rolled with the fiber ribbon of FIG. 1; and

FIG. 7 shows a color-coded filler rod attached to the ribbon of FIG. 1.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

The present disclosure is directed to a rolled optical fiber ribbon and methods of manufacturing the same. The optical fiber ribbon is manufactured in a rolled configuration so that the rolled configuration is the natural state for the optical fiber ribbon. Accordingly. the optical fiber ribbon can be stored coiled on a reel in the rolled configuration. Such fiber ribbons can be paid out of storage reels in the rolled configuration, which facilitates subsequent cable manufacturing in that the optical fiber ribbons can be fed directly from the storage reels into the cable jacket or core stranding fixture. When splicing (e.g., mass-fusion splicing) or connectorization (i.e., terminating the optical fibers at one or more optical connectors) is needed, the optical fiber ribbon can be transitioned to a planar configuration or the optical fibers can be separated out into a planar configuration.

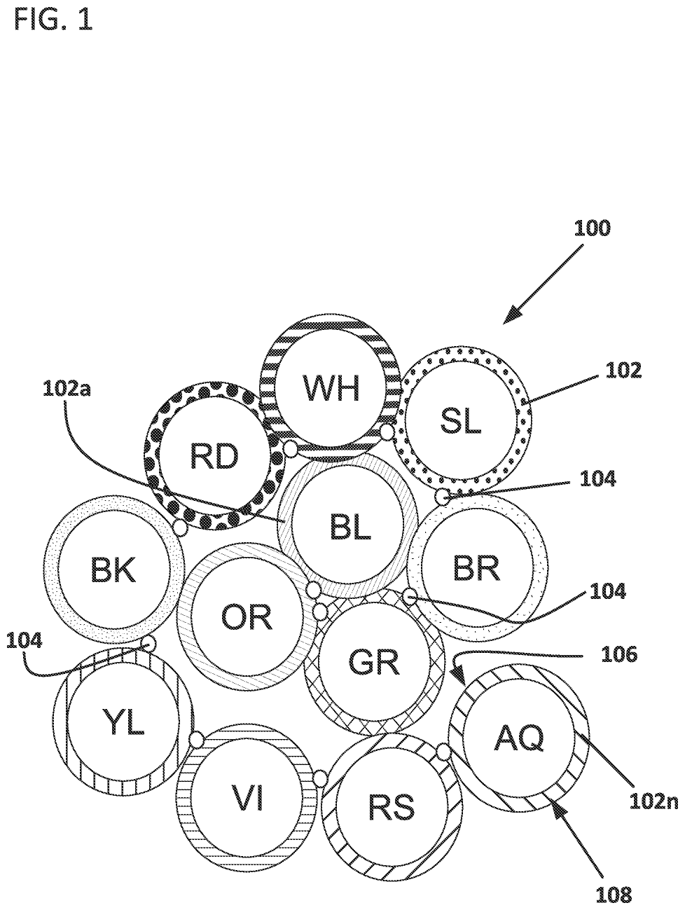

Referring to FIG. 1, two or more optical fibers 102 can be bonded (e.g., adhesively bonded) together in a consecutive sequence from a first fiber 102a to a last fiber 102n to form an optical fiber ribbon 100. The ribbon 100 has a first side 106 (e.g., a first major side) and an opposite second side 108 (e.g., a second major side) that each extend between opposite lateral edges of the ribbon 100. In certain examples, the first fiber 102a forms the first lateral edge of the ribbon 100 and the last fiber 102n forms the second lateral edge of the ribbon 100. In some implementations, the rolled optical fiber ribbon 100 may have a spiral-shaped transverse cross-sectional profile. In other implementations, the rolled optical fiber ribbon 100 may have a cylindrical transverse cross-sectional profile.

In the example shown, twelve optical fibers 102 are bonded together to form the fiber ribbon 100. In other implementations, the fiber ribbon 100 may include a greater or lesser number (e.g., four, six, eight, ten, sixteen, twenty-four, thirty-six, etc.) of fibers 102. The fiber ribbon 100 maintains the optical fibers 102 in the consecutive sequence so that specific ones of the optical fibers 102 can be identified at both axial ends of the fiber ribbon 100.

The optical fibers 102 are bonded together using bonding material 104 which may include a curable material having adhesive characteristics such as a curable adhesive. In certain examples, the bonding material 104 includes a curable material that is cured via time or the application of energy (e.g., radiant energy such as heat or light (e.g., ultraviolet radiation)). In certain examples, the bonding material 104 is an adhesive such as an epoxy. In certain examples, the bonding material 104 can include a thermoplastic material or a thermoset material. In some implementations, the bonding material 104 is applied to the optical fibers 102 at the first side 106 of the ribbon 100 (e.g., see FIG. 1). In other implementations, the bonding material 104 is applied to the optical fibers 102 at the second side 108 of the ribbon 100.

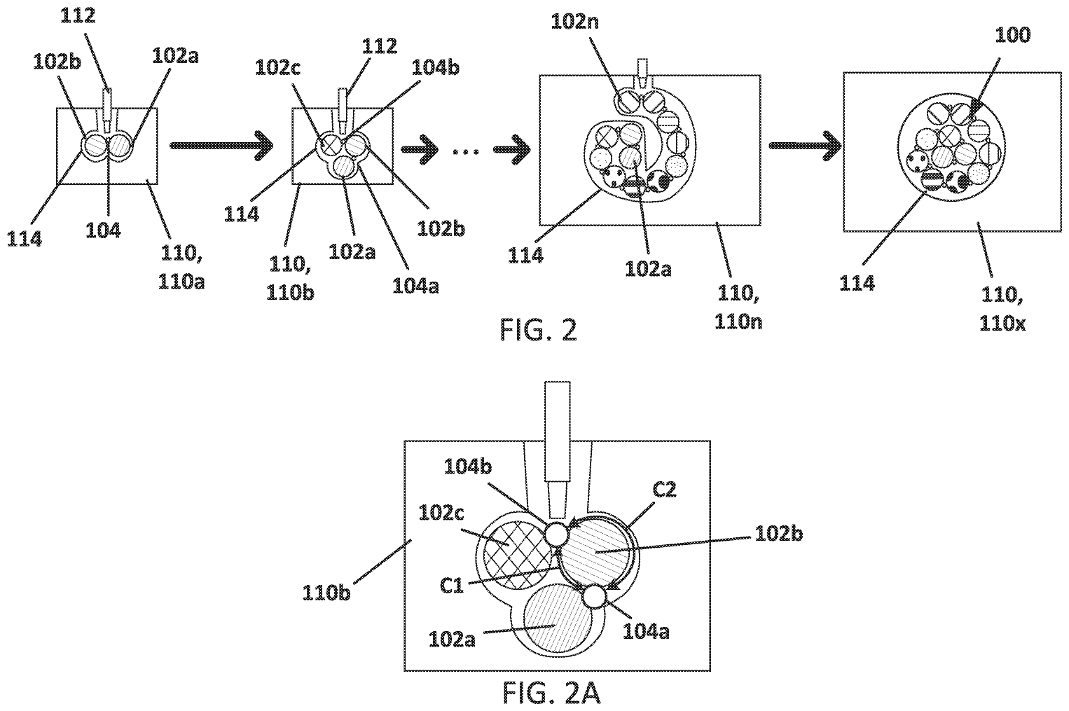

Referring to FIG. 2, the optical fiber ribbon 100 is manufactured in the rolled configuration. In general, manufacturing the optical fiber ribbon 100 includes curling the optical fiber ribbon 100 in a rolled configuration as the optical fibers 102 are being sequentially added to the optical fiber ribbon 100. For example, two optical fibers 102a, 102b are bonded together at a first fixture 110a to start a fiber ribbon 100. At each subsequent fixture 110, the previously bonded optical fibers 102 are indexed to align a lateral end of the ribbon 100 with a new optical fiber 102 (e.g., optical fiber 102c, 102n, etc.) to be added to the ribbon 100 at the lateral end. This index and adhere process is repeated until all of the optical fibers 102 are added to the ribbon 100.

In certain implementations, the optical fibers 102 are indexed so that a new optical fiber 102 to be added is aligned with a previous optical fiber 102 at a dispenser 112. For example, the optical fibers 102 are aligned so that contiguous surfaces of the optical fibers 102 are aligned beneath the dispenser 112. In some implementations, the dispenser 112 applies a continuous line of bonding material 104 along the contiguous surfaces. In other implementations, the dispenser 112 applies intermittent volumes (e.g., beads) of bonding material 104 along the contiguous surfaces.

In certain implementations. each indexing fixture 110 includes a former 114 (e.g., a fiber positioner) that shapes the optical fibers 102 and aligns the contiguous surfaces at the dispenser 112. In some implementations, the former 114 of each indexing fixture 112 is shaped differently to accommodate a different number of optical fibers 102 of the ribbon 100. For example, the former 114 of the first indexing fixture of FIG. 2 accommodates two optical fibers 102a, 102b whereas the former 114 of the nth indexing fixture 110n presses together an inner portion of a spiral and aligns an outer leg of the spiral with the dispenser 112. In certain examples, the former 114 of a final indexing fixture 110n or a curing fixture 111 presses the outer leg of the spiral towards the inner portion of the spiral. In other implementations, the former 114 of each indexing fixture 112 has a common shape.

In certain implementations, because the optical fibers 102 are indexed before the bonding material 104 is dispensed, the bonding material 104 applied between the first and second optical fibers 102a, 102b of the ribbon 100 need not be circumferentially opposite the bonding material 104 applied between the second and third optical fibers 102b, 102c. For example, as shown in FIG. 2A, the bonding material bead 104a bonding the second optical fiber 102b to the first optical fiber 102a is not circumferentially opposite the bonding material bead 104b bonding the second optical fiber 102b to the third optical fiber 102c. Rather, a first circumferential distance C1 between the beads 104a, 104b is smaller than a second circumferential distance C2. Such placement of the bonding material 104 helps to hold the fiber ribbon 100 in the rolled configuration.

In some implementations, the bonding material 104 is cured at the indexing fixture 110 after being applied to hold the fibers 102 in the curled positon. In other implementations. the respective bonding material 104 is partially cured at each indexing fixture 100. The partial curing is sufficient to hold the fibers 102 in position, but enables some stretching or deformation of the bonding material 104 to accommodate further rolling of the ribbon 100. In such implementations, the final cure can be applied to the bonding material at the final indexing fixture 110n or at a curing fixture 111 that also compresses or otherwise shapes the ribbon 100 into a final configuration.

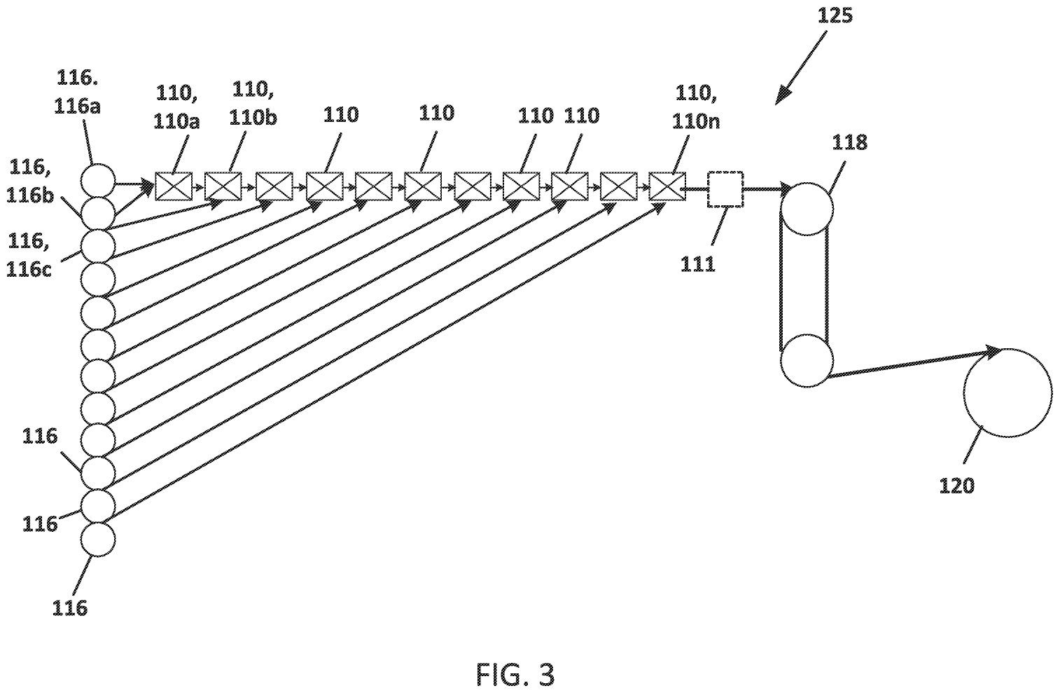

FIG. 3 illustrates an example manufacturing system 125 with which the rolled fiber ribbon 100 of FIG. 1 can be formed. The manufacturing system 125 includes multiple indexing fixtures 110 arranged in a sequential chain. Multiple payout reels 116 feed optical fibers 102 to the chain of indexing fixtures 110. The optical fiber 100 leaves the final indexing fixture (or a curing fixture 111) and is taken up on a storage reel 120. In certain examples, a fiber ribbon accumulator 118 may be disposed between the fixtures 110, 111 and the storage reel 120 to maintain line tension and facilitate replacing payout reels 116.

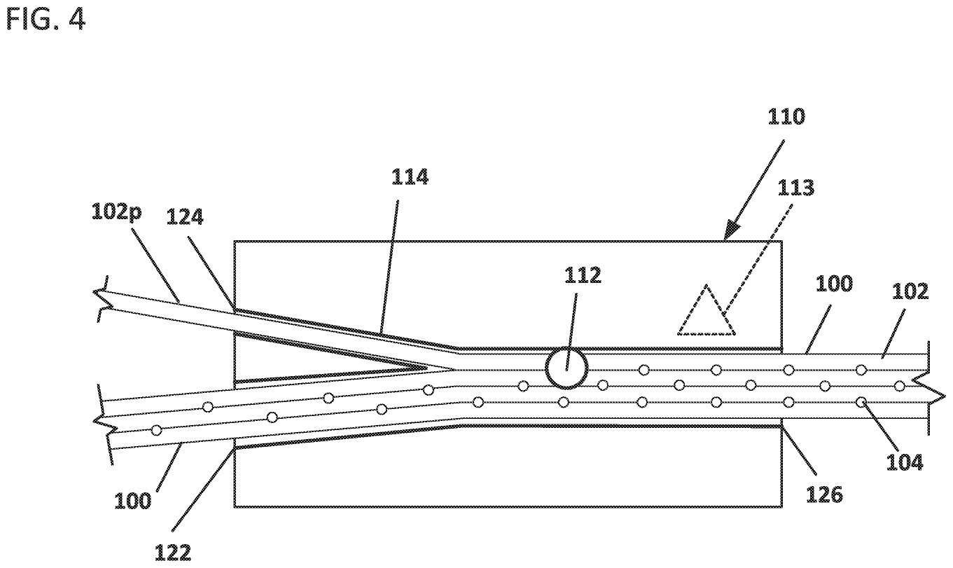

FIG. 4 illustrates an example indexing fixture 110. Each fixture 110 includes a first input 122, a second input 124, and an output 126. The first input 122 is configured to receive the bonded optical fibers 102 of the previous fixture 110. In the case of the first indexing fixture 110a, the first input 122 receives a first optical fiber 102a. The second input 122 is configured to receive the new fiber 102p to be added to the ribbon 100. A former 114 routes the optical fibers 102, 102p together so that the new optical fiber 102p is positioned at the lateral end of the existing ribbon 100. The former 114 aligns contiguous surfaces of the new fiber 102p and the fiber 102 at the lateral end of the ribbon 100 under the bonding material dispenser 112. The newly enlarged ribbon 100 exits the fixture 110 through the output 126.

In some implementations, the optical fibers 102 are always added to the same lateral edge of the ribbon 100 so that the first optical fiber 102a always defines the other lateral edge of the ribbon 100. In other implementations, new optical fibers 102 can be added to either lateral edge of the ribbon 100. In such implementations, the starting optical fibers 102a, 102b would be selected from the middle of the ribbon sequence instead of the end of the ribbon sequence.

In certain implementations, the bonding material dispenser 112 remains stationary within the fixture 110. In certain examples, the bonding material dispensers 112 of the fixtures 110 have a common orientation (e.g., pointing straight down). In some implementations, the fixture 110 includes a cure device 113 (e.g., a light source such as an ultraviolet (UV) light source, a heat source, a chemical sprayer, etc.). In some examples, the cure device 113 is configured to affect only the bonding material 104 applied by the dispenser 112 of the fixture 110. In other examples, the cure device 113 broadly applies a curing agent (e.g., light, heat, chemical, etc.) to other portions of the ribbon 100 or the entire ribbon 100.

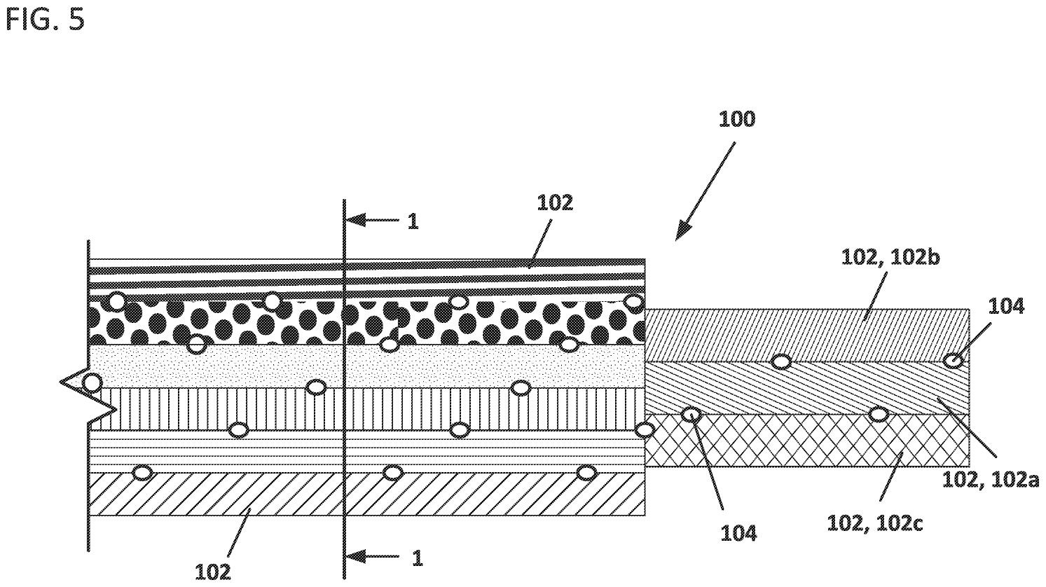

Referring back to FIG. 3, in the example shown, the first indexing fixture 110a receives the first optical fiber 102a from the first payout reel 116a at the first input 122 and the second optical fiber 102b from the second payout reel 116b at the second input 124. The first indexing fixture 110a bonds together the first and second fibers 102a, 102b and outputs the bonded fibers 102a, 102b to the first input 122 of the second indexing fixture 110b. The second input 124 of the second indexing fixture 110b receives a third optical fiber 102c from a third payout reel 116c. This process continues until the indexing fixture 110n receives the incomplete fiber ribbon 100 at the first input 122 and the last fiber 102n to add to the ribbon 100 at the second input 124 and outputs the ribbon 100 (see FIG. 5) at the output 126.

In some implementations, the last indexing fixture 110n cures all of the bonding material 104 (e.g., by shining a wide-beam of light (e.g. UV light) across the entire ribbon 100). In other implementations, the last indexing fixture 110n cures the bonding material 104 applied by the last fixture 110n (e.g., by shining a narrow beam of light (e.g., UV light) at the newly applied bonding material 104). In certain implementations, the fiber ribbon 100 output from the last indexing fixture 100n is input into a curing fixture 111 at which the fiber ribbon 100 is exposed to light, heat, chemicals, or other environment that results in curing of the bonding material 104. In certain implementations, the curing fixture 111 also may compress or otherwise finalize the rolled form of the ribbon 100.

In certain implementations, the optical fiber ribbon 100 is helically twisted by the manufacturing system 125. For example, the fiber ribbon 100 may be twisted along a lay length over an axial length of the ribbon 100 in addition to being curled into a rolled configuration as shown in FIG. 1. In some examples, the fiber ribbon 100 is helically twisted. In other examples, the fiber ribbon 100 is Z-stranded. In certain implementations, the fiber ribbon 100 can be twisted in a first direction (e.g., clockwise. counter-clockwise, etc.) and can be stranded with another ribbon 100 or other component in an opposite second direction. Stranding the fiber ribbon 100 in the opposite direction as the twist may relieve tension on the optical fibers 102 of the ribbon 100. For example, a lay length of the stranding can be selected to remove the twist from the fiber 100.

In certain implementations, the optical fiber ribbon 100 can be stranded (e.g., helically stranded, Z-stranded, etc.) with other optical components. In certain examples, the optical fiber ribbon 100 can be stranded with one or more additional fiber ribbons 100. In certain examples, the optical fiber ribbon 100 can be stranded with one or more electrical conductors to form a hybrid cable. In certain examples, the fiber ribbon 100 can be stranded with one or more strength members. For example, the fiber ribbon 100 can be wound around a central rod (e.g., a glass-reinforced plastic rod). In another example, the fiber ribbon 100 can be stranded with aramid yarn or other flexible strength member. In certain examples, the fiber ribbon 100 is stranded with a dielectric filler rod. In certain examples, the fiber ribbon 100 is stranded with a water blocking element (e.g., a water-blocking tape).

In certain implementations, the optical fiber ribbon 100 can be stranded with one or more color-coded indicators 130 (e.g., colored thread, colored filler rod, colored water blocking tape, etc.). The color-coded indicators 130 uniquely identify a particular fiber ribbon 100. Accordingly, a specific ribbon 100 within a multi-ribbon cable could be identified. The ability to identify specific ribbons 100 within the cable allows tracing of individual fibers 102 within the cable possible.

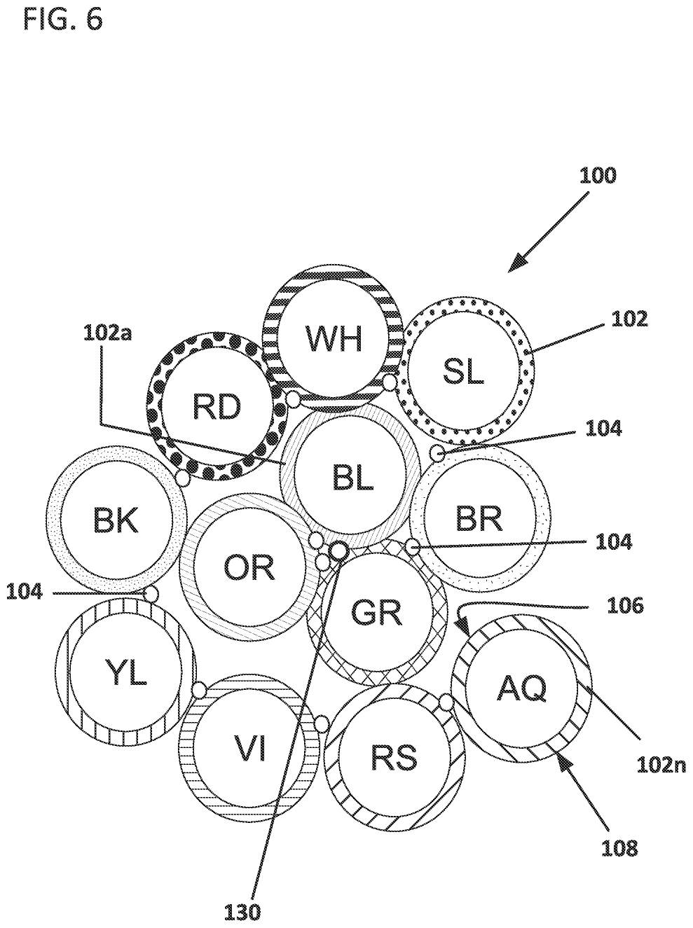

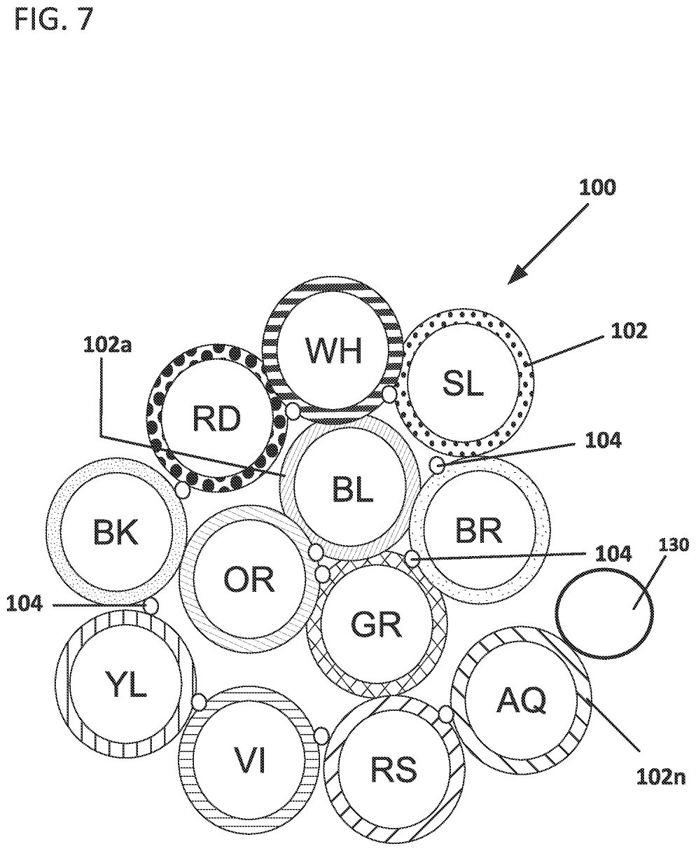

In some examples, the color-coded indicator 130 is enfolded or otherwise loosely held within the fiber ribbon 100. For example, the ribbon 100 can be curled around the color-coded indicator 130. In the example shown in FIG. 6, the first three optical fibers 102a, 102b, 102c of the ribbon 100 are curled around the color-coded indicator 130. In other implementations, the color-coded indicator 130 may be wrapped around an exterior of the rolled ribbon 100. For example, the indicator 130 may help maintain the ribbon 100 in the rolled configuration. In still other implementations, the color-coded indicator 130 may be attached (e.g., adhesively bonded) to one or more of the optical fibers 102 of the ribbon 100 (e.g., see FIG. 7). In certain examples, the indicator 130 may form one of the lateral ends of the ribbon 100 until the ribbon 100 is separated into individual fibers 102 for use. In such examples, the indicator 130 may be added to the ribbon 100 using one of the indexing fixtures 110 as if the indicator 130 were a new optical fiber.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A method of manufacturing an optical fiber ribbon in a rolled configuration, the method comprising:
rolling the optical fiber ribbon as a plurality of fibers are sequentially added to the optical fiber ribbon; and
progressively applying bonding material as the optical fibers are sequentially added to the optical fiber ribbon.

2. The method of claim 1, wherein progressively applying bonding material comprises applying bonding material to bond together adjacent ones of the plurality of optical fibers as the optical fiber ribbon is being rolled into a spiral configuration.

3. The method of claim 1, wherein applying bonding material comprises applying the bonding material in continuous beads between adjacent fibers.

4. The method of claim 1, wherein applying bonding material comprises applying the bonding material in intermittent volumes between adjacent fibers.

5. The method of claim 2, wherein the optical fibers extend straight along a longitudinal axis of the optical fiber ribbon when the optical fiber ribbon is rolled into the spiral configuration.

6. The method of claim 2, wherein the optical fibers wrap helically about a longitudinal axis of the optical fiber ribbon when the optical fiber ribbon is rolled into the spiral configuration.

7. The method of claim 1, further comprising spooling the optical fiber ribbon on a take-up spool while the optical fiber ribbon is disposed in the spiral configuration.

8. The method of claim 1, wherein applying bonding material comprises:
a) indexing bonded ones of the optical fibers until a fiber to be added to the optical fiber ribbon is aligned with a fiber most recently added to the optical fiber ribbon;
b) bonding the fiber to be added to the optical fiber ribbon to the fiber most recently added to the optical fiber ribbon; and
c) repeating steps (a) and (b) until the optical fiber ribbon is formed.

9. The method of claim 1, further comprising twisting the fiber ribbon in a first direction, either clockwise or counterclockwise, so as to create a helically twisted rolled ribbon.

10. The method of claim 9, further comprising:
stranding the helically twisted rollable ribbon and additional communication element in a second direction that is opposite to the first direction to form a core strand.

11. The method of claim 10, wherein the helically twisted rollable ribbon includes a first helically twisted rollable ribbon; and wherein the additional communication element includes a second helically twisted rollable ribbon.

12. The method of claim 10, wherein the additional communication element includes a dielectric filler rod.

13. The method of claim 10, wherein the additional communication element includes an electrical conductor.

14. The method of claim 10, further comprising:
selecting a lay length of the core strand in the second direction to mostly remove a twist from the fiber ribbon in the first direction.

15. The method of claim 1, further comprising attaching a color-coded identification element to the rolled ribbon.

16.-25. (canceled)

26. A method of manufacturing a flexible ribbon cable, the method comprising:
a) aligning a circumferential location of a first optical fiber with a first circumferential location of a second optical fiber to form a contiguous section;
b) applying bonding material to the contiguous section;
c) aligning a first circumferential location of a third optical fiber with a second circumferential location of the second optical fiber to form a contiguous section between the second and third optical fibers, the second circumferential location not being circumferentially opposite the first circumferential location of the second optical fiber; and
d) applying bonding material to the contiguous section between the second and third optical fibers so that the first, second, and third optical fibers form a sequence of optical fibers with the first optical fiber forming a first fiber in the sequence and the third optical fiber forming a last fiber in the sequence.

27. The method of claim 26, wherein the flexible ribbon cable is formed from N optical fibers, and wherein the method further comprises:
e) aligning a first circumferential location of a new one of the N optical fibers with a second circumferential location of a last optical fiber in the sequence to form a respective contiguous section, wherein the second circumferential location of the last optical fiber is not circumferentially opposite the first circumferential location of the last optical fiber; and
f) applying bonding material at each contiguous section so that the new optical fiber then forms the last fiber in the sequence until the sequence includes the N optical fibers.

28. The method of claim 27, further comprising curing the bonding material at each of the contiguous sections of the optical fibers.

29. The method of claim 28, wherein curing the bonding material occurs after the bonding material has been applied to the contiguous sections of all N of the optical fibers.

30. The method of claim 27, wherein N=12, 16 or 24.

31.-32. (canceled)

33. The method of claim 27, wherein aligning the first circumferential location of the new one of the N optical fibers with the second circumferential location of the last optical fiber in the sequence comprises indexing the sequence of optical fibers in a spiral configuration.

34. The method of claim 33, further comprising tightening the spiral configuration when bonding material has been applied to the contiguous sections of all N of the optical fibers.

35.-36. (canceled)
